(19) United States
(12) Patent Application Publication
(10) Pub. No.: US 2025/0265520 A1
(43) Pub. Date: Aug. 21, 2025

(54) AI- AND IoT-DRIVEN REAL-TIME CONSTRUCTION MANAGEMENT SYSTEM

(71) Applicant: Joshua Giles, Houston, TX (US)

(72) Inventor: Joshua Giles, Houston, TX (US)

(21) Appl. No.: 19/068,681

(22) Filed: Mar. 3, 2025

(51) Int. Cl. G06Q 10/0631; G01D 21/02; G06Q 50/08; G08B 21/02; G16Y 10/30

(52) U.S. Cl. CPC G06Q 10/06312; G01D 21/02; G06Q 10/06313; G06Q 50/08; G08B 21/02; G16Y 10/30

(57) ABSTRACT

An AI-and IoT-driven real-time construction management system continuously acquires and analyzes high-frequency sensor data, including temperature, GPS, and RFID inputs. Utilizing advanced predictive machine learning and reinforcement learning algorithms, the system forecasts schedule deviations and resource conflicts with an accuracy exceeding 90%. Upon identifying deviations, it autonomously triggers corrective actions—such as reallocating resources or adjusting task sequences—typically within five seconds. This integrated, closed-loop management approach seamlessly interfaces with external project management tools, achieving approximately 15-20% improved schedule adherence and notable cost reductions based on preliminary data. The system's modular architecture supports diverse sensor technologies and AI frameworks, ensuring adaptability and sustained performance in large-scale, dynamic construction environments.

### FIELD OF THE INVENTION

The present invention relates generally to the field of construction project management and, more particularly, to an AI-and IoT-driven system that provides real-time monitoring, forecasting, and automated control of construction activities to enhance schedule adherence, resource utilization, and safety.

### BACKGROUND OF THE INVENTION

Large-scale construction projects commonly face schedule overruns, cost inflation, and inefficiencies stemming from late problem detection and fragmented data sources. Conventional project management tools typically rely on manual updates and post hoc analysis, lacking the ability to automatically integrate high-frequency sensor data or generate immediate corrective actions. As a result, emerging issues-such as equipment downtime or materials delays-are often recognized too late, causing a ripple effect across the project schedule.

Many existing solutions either:
1. Provide dashboard-style analytics that are updated periodically (e.g., daily or weekly), leading to delays in responding to dynamic site conditions.
2. Integrate IoT sensors but use them merely to collect and log data, without employing robust machine learning or AI-based predictive strategies.
3. Offer advisory outputs that require manual interpretation and manual re-sequencing of tasks, thereby missing opportunities for automated, real-time adjustments.

Hence, there is a need for an integrated AI-and IoT-driven system that continuously monitors on-site conditions, predicts potential schedule deviations, and executes or recommends appropriate corrective measures in near real time. In contemplating this need, the applicant envisions a multi-tier claiming strategy wherein broad independent claims capture the core real-time AI-and IoT-enabled functionality, while narrower dependent claims specify various sensor types, AI architectures, or communication protocols. The approach preserves broad protection and provides fallback positions, should the broadest claims face prior art. This ensures the invention's foundational innovations—rapid data ingestion, sub-second decision-making, and automated corrective actions—remain broadly protected while providing fallback positions if the most general claims face prior art. By coupling functional recitations with optional structural details, the applicant further deters design-arounds, as the invention's essence extends to any substantially equivalent system achieving the same real-time construction site control outcomes. In drafting its claims, the applicant contemplates reciting broad, functional language in at least one independent claim, capturing the real-time AI-and IoT-enabled management capabilities. For example, in an independent claim, the system may be defined as being “configured to achieve real-time data processing and corrective action irrespective of the specific Al algorithm or sensor technology employed.” At the same time, narrower dependent claims may specify additional details (e.g., particular sensor types, AI algorithms, or communication protocols) to address any newly cited prior art. By layering claims in this manner, the applicant maintains wide coverage over the inventive concept while ensuring fallback positions remain available if broader claims are challenged. In maintaining such a layered approach, the applicant also contemplates explicitly reciting, in at least one independent claim, the core functional aspects of real-time AI-driven construction management, while preserving dependent claims that integrate various specific features. This ensures that should any broad claim be restricted, narrower dependent claims will remain to capture the inventive concept.

### Additional Note on Layered Claims:

“To preserve the broadest possible scope, the applicant contemplates a multi-tier claim strategy in which one or more independent claims recite the core real-time AI-and IoT-enabled functionality. Dependent claims may then specify particular sensor types, Al architectures, or communication protocols to provide narrower fallback positions if prior art challenges arise. This layered approach ensures that even if certain embodiments are disallowed, the remaining claims continue to protect the overarching inventive concept and deter design-arounds.”

It is intended that the dependent claims serve solely as fallback positions and shall not be construed to limit the scope of the independent claims, which are drafted in broad functional terms.

### SUMMARY OF THE INVENTION

The present invention discloses an AI-and IoT-driven real-time construction management system that collects, analyzes, and acts upon data from multiple sensors and project management sources in sub-second intervals. By uniting high-frequency IoT data with advanced machine learning (ML) and reinforcement learning (RL) techniques, the system proactively identifies potential or emerging issues—such as schedule slippage or site hazards—and automatically initiates corrective actions or recommended solutions.

### Key Features

1. Continuous Data Integration
A network of on-site sensors (e.g., RFID, temperature, vibration, GPS) streams data to an edge computing module that normalizes and timestamps inputs within a defined latency (e.g., ≤250 ms). This ensures a precise and up-to-date representation of on-site conditions.
2. Predictive & Prescriptive AI
A long short-term memory (LSTM) model forecasts upcoming schedule delays or resource conflicts with <10% average error, while a reinforcement learning engine prescribes immediate corrective actions (e.g., reassigning labor, re-sequencing tasks) within ≤5 seconds of an identified deviation. These examples are non-limiting; alternative machine learning methods that yield similar real-time performance and corrective-action capabilities are equally contemplated within the scope of this invention.
3. Closed-Loop Control & Integration
The system's control interface can directly dispatch machine commands, safety alerts, or scheduling updates, ensuring sub-second feedback loops. Simultaneously, an integration interface (e.g., RESTful APIs) seamlessly updates external project management software.
4. Demonstrated Performance Improvements
Preliminary or pilot data (see [PILOT DATA REFERENCE]) suggests approximately 15-20% improved schedule adherence and 10-15% cost savings over projects managed with traditional methods. These results highlight unexpected benefits beyond mere automation of known processes. It is expressly noted that the pilot data and expected performance figures provided herein are illustrative examples and do not limit the scope or potential outcomes of the invention under varying conditions. However, it should be understood that these figures derive from pilot or simulated scenarios and reflect expected or preliminary results rather than guaranteed outcomes in every deployment. This data is presented as an illustrative example of the system's potential benefits, not as a limiting performance benchmark. Moreover, the invention is not restricted to achieving precisely 15-20% improvements; any comparable or greater efficiency gains, whether from alternative AI models or different sensor configurations, remain within the scope of this disclosure.
5. Modular, Future-Proof Design
The invention accommodates a range of sensor types and AI algorithms. An alternative embodiment can include ZigBee or Wi-Fi sensors, or advanced ML architectures such as transformer-based models, thereby future-proofing the system against evolving technologies. In various embodiments, the system may incorporate other sensor or AI technologies that achieve similar sub-second data throughput and automated corrective action. The invention is thus not limited to specific architectures (e.g., LSTM, RL, ZigBee) but encompasses any substantially equivalent frameworks or standards that fulfill the real-time construction management objectives described herein.

In addition, any new AI or sensor technology meeting substantially similar functional criteria—such as sub-second data processing or automated corrective actions—falls within the scope of the invention. This ensures the invention remains adaptable to ongoing technological developments in hardware, software, or communication standards, without disclaiming potential future variations that achieve the same essential real-time control objectives.

Furthermore, the system may readily adapt to next-generation communication standards (e.g., 5G, 6G, or mesh networks) and emerging computing hardware (such as neuromorphic or quantum-based accelerators), provided they meet substantially the same functional timing and real-time control criteria described herein.

In addition, the invention contemplates adopting future sensor protocols, novel wireless standards, or newly emergent AI architectures (beyond LSTM or RL) that achieve substantially the same real-time monitoring and corrective-action functionality. For instance, the system may employ alternative sensor protocols or AI algorithms—such as transformer-based models or support vector machines (SVMs)—without departing from the core inventive concept. By referencing such alternative embodiments, the applicant intends to safeguard the invention's adaptability over time. In no way should these examples be viewed as limiting; rather, they ensure that successors to today's sensor or AI technologies—so long as they achieve sub-second monitoring and corrective actions—fall within the scope of protection. None of these variations are intended to limit claim scope; rather, they illustrate how the system's modular design accommodates ongoing technological advances without departing from the invention's core inventive concepts.

While the invention's pilot data illustrates notable gains—e.g., 15-20% schedule adherence improvement—these quantifications are merely exemplary. Any demonstration of improved responsiveness or schedule outcomes beyond conventional solutions may suffice to show the nonobvious synergy of real-time IoT and advanced AI strategies employed herein, without limiting the scope to specific percentages or performance benchmarks.

It should be understood that while pilot or simulated data suggests notable efficiency gains, these figures merely illustrate one example of the system's potential. Equivalent or greater results could be achieved under different project conditions or using updated AI models, consistent with the invention's broad scope.

Through these innovations, the invention transforms how construction sites are managed, shifting from reactive oversight to proactive, data-driven control. The integration of real-time IoT data with advanced AI algorithms results in concrete operational benefits—such as enhanced safety, immediate corrective actions, and improved resource utilization—that underscore the invention's tangible technical contributions in line with current patent eligibility standards.

### DETAILED DESCRIPTION

### I. Definitions

1. “Real-Time”: For purposes of this specification, “real-time” refers to data acquisition, processing, and initiation of a corrective response all occurring within a combined latency of about 1 second or less (sub-second intervals). Preferably, sensor data is timestamped within ≤250 ms of acquisition, and corrective actions or alerts are initiated within ≤5 seconds of detecting a threshold deviation. (These parameters are provided as examples under standard operating conditions and are not intended to limit the invention to any specific environmental or sensor performance conditions.) For the avoidance of doubt, any mention of “<250 ms” or “<5 seconds” is intended as an exemplary latency range. The invention includes other implementations where data processing or corrective actions occur within substantially real-time intervals—such as within a few seconds—so long as the rapid-response objectives are achieved. These numerical figures are thus illustrative and not strict requirements.
2. “AI Module”: A computing environment (hardware and/or software) that hosts at least a machine learning (e.g., LSTM) and reinforcement learning (RL) engine. This module predicts possible schedule or resource issues (predictive) and prescribes or executes solutions (prescriptive).
3. “Edge Computing Module”: A localized computing system deployed on-site or near-site, configured to preprocess, filter, or aggregate incoming sensor data before forwarding it to the AI module. This helps maintain low-latency and reduces bandwidth demands.
4. “Computer-Readable Medium”: As used herein, a “computer-readable medium” is any tangible storage device that stores instructions for execution by one or more processors. This includes, but is not limited to, random access memory (RAM), read-only memory (ROM), flash memory, hard disk drives, optical disks, or any combination thereof. As further used in this specification, a “non-transitory computer-readable medium” excludes signals or carrier waves and is intended to encompass only tangible, non-transitory media.

### II. Exemplary System Architecture

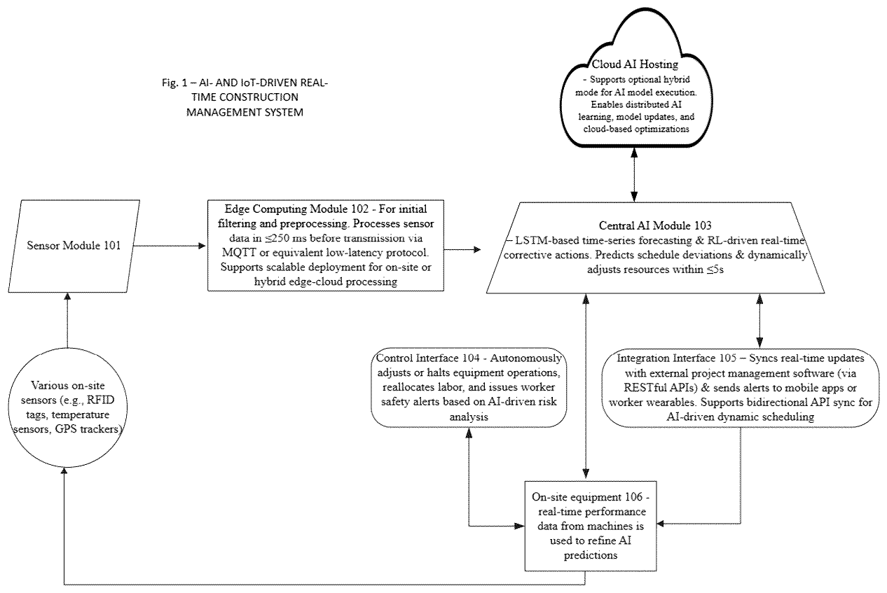

Referring now to FIG. 1, the AI-and IoT-driven real-time construction management system 100 comprises:

### 1. Sensor Module (101)

A network of sensors capable of capturing environmental, positional, or operational data. Examples include RFID tags on materials, temperature sensors for curing concrete, vibration or strain gauges for structural feedback, and GPS modules on equipment for real-time location tracking. Each sensor reading is timestamped within about 250 ms via an on-site collector or gateway.

### 2. Edge Computing Module (102).

Located on-site to buffer and preprocess sensor streams, often using an MQTT (Message Queuing Telemetry Transport) protocol or a similarly lightweight IoT communication protocol. Preprocessing can include de-noising or aggregating multiple sensor feeds, thereby reducing latency and ensuring near-instant data availability for the AI Module.

### 3. AI Module (103)

Implements at least two specialized algorithms:
   1. LSTM Algorithm for time-series forecasting, predicting future delays or anomalies (targeting an <10% error margin based on pilot data).
   2. Reinforcement Learning (RL) Agent that autonomously re-sequences tasks or issues corrective commands when schedule deviations exceed a threshold, typically ≥15% deviance from planned progress or timeline.
The AI module is designed to initiate control actions within about 5 seconds after detecting a significant deviation or risk event.

### 4. Control Interface (104)

Communicates direct machine commands or alerts to on-site equipment (e.g., cranes, pumps, robotic systems) and to wearable devices used by workers. For instance, if the AI detects a hazard, it can automatically halt nearby machinery or dispatch a safety alert.

### 5. Integration Interface (105)

Ensures bidirectional data flow with external project management software (e.g., scheduling tools, ERP systems) via RESTful APIs or other standardized protocols. This keeps high-level project schedules and resource data synchronized in real time with the system's predictive insights.

### III. Operational Workflow

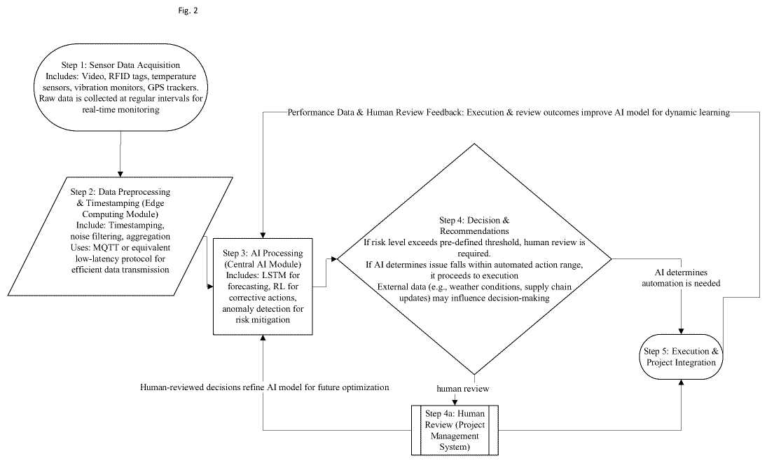

Referring to FIG. 2, a typical operational cycle may be summarized as follows:
1. Data Acquisition: Sensor Module (101) streams data to the Edge Computing Module (102), which timestamps and merges inputs within about 250 ms.
2. AI Analysis: The AI Module (103) receives the data, runs the LSTM predictor to identify any upcoming schedule or resource bottlenecks, and evaluates the severity.
3. Decision-Making: If the predicted deviation surpasses a user-defined threshold (e.g., 15% behind schedule), the RL agent determines the optimal corrective action-such as reassigning a crane to a delayed task or reordering materials.
4. Implementation:
   Via Control Interface (104), the system issues immediate commands (e.g., adjust machine parameters, allocate additional labor).
   Via Integration Interface (105), the system updates the project schedule in external software, logging the change for the project manager's dashboard.
5. Continuous Monitoring: The system cycles back to step 1, using updated data to refine subsequent predictions (a form of adaptive learning).

### IV. Example Embodiments & Best Mode

Below is an exemplary embodiment, believed to represent the best mode:

### 1. Sensors & Edge:

Temperature sensors measure curing conditions for concrete, with sample rates of 1 sample/second.
GPS modules on heavy equipment broadcast location every 0.5 seconds, aggregated via MQTT.

### 2. AI Module:

An LSTM network trained on historical construction logs (≥1 TB of data) to forecast day-by-day schedule progress within <10% error.
A reinforcement learning policy that, upon detecting a ≥15% slip in real-time schedule alignment, automatically triggers resource adjustments within 5 seconds.
For example, the LSTM network may be trained using historical records of project timelines, material delivery times, and environmental data. These logs can be split into training and validation sets, with standard machine-learning workflows applied (e.g., cleaning outliers, adjusting learning rates, tuning the number of LSTM layers). Such steps ensure that an examiner of ordinary skill could replicate the model's predictive capabilities using widely available AI frameworks. In some embodiments, the LSTM model may be trained on approximately 1 TB of historical project data, using a common batch size (e.g., 32-128) over 50-100 training epochs, with a learning rate in the range of about 0.001-0.01. These values are illustrative and not intended to limit the scope of the invention. One of ordinary skill in the art could select different parameter ranges or data volumes, as the invention primarily lies in achieving substantially real-time predictions and corrective actions, rather than any specific training configuration.
   3. Pilot Data Findings (see also [PILOT DATA TABLE]):
The prototype reduced equipment downtime by ˜12% and improved schedule adherence by ˜18% compared to baseline methods.

### 4. Disclaimers:

Future AI Models: While LSTM+RL is described here (see Listing 1 for an illustrative pseudo-code example), any AI approach—such as, but not limited to, transformers or SVMs—capable of achieving substantially the same sub-second decision-making and corrective-action performance is included within the scope of this invention. No single algorithm should be construed as limiting, as the overarching inventive concept lies in the real-time integration of AI and IoT for continuous construction site management.
   1. Listing 1: Example Pseudo-Code for Real-Time Construction Management AI. Note: The following example, including the pseudocode and flowchart (see FIG. X), is provided for illustrative purposes only and is not intended to limit the inventive concept to this specific implementation.
      1. Initialize System:
         1. Connect to Sensor Module (101) for real-time data streams
         2. Set up Edge Computing Module (102) for data buffering and pre-processing
         3. Load AI Module (103) with pre-trained models (e.g., LSTM, RL agent)
      2. Data Acquisition & Preprocessing:
         1. rawData=SensorModule.readData ( )//read from sensors
         2. preprocessedData=EdgeModule.filter (rawData)//remove noise, add timestamps
      3. AI Analysis (Predictive):
         1. prediction=LSTMModel.predict (preprocessedData) if prediction.delay>threshold://schedule slip detected
      4. Decision-Making (Prescriptive):
         1. correctiveAction=RLAgent.decide (prediction, currentSchedule) if correctiveAction.isNeeded ( )//reassign resources, reorder tasks, etc.
      5. Implement Action:
         1. ControlInterface.executeAction (correctiveAction) IntegrationInterface.updateExternalSystems (correctiveAction)
      6. Continuous Monitoring:
         1. //Loop back to data acquisition repeat steps 2-5 at defined intervals
Alternative Sensors: The system may incorporate ZigBee or Wi-Fi sensors, provided they meet functional timing criteria.
Scalability: The best mode depicts an on-site edge gateway, but cloud-based or hybrid approaches are equally contemplated.

### V. Additional Embodiments/Fallback Positions

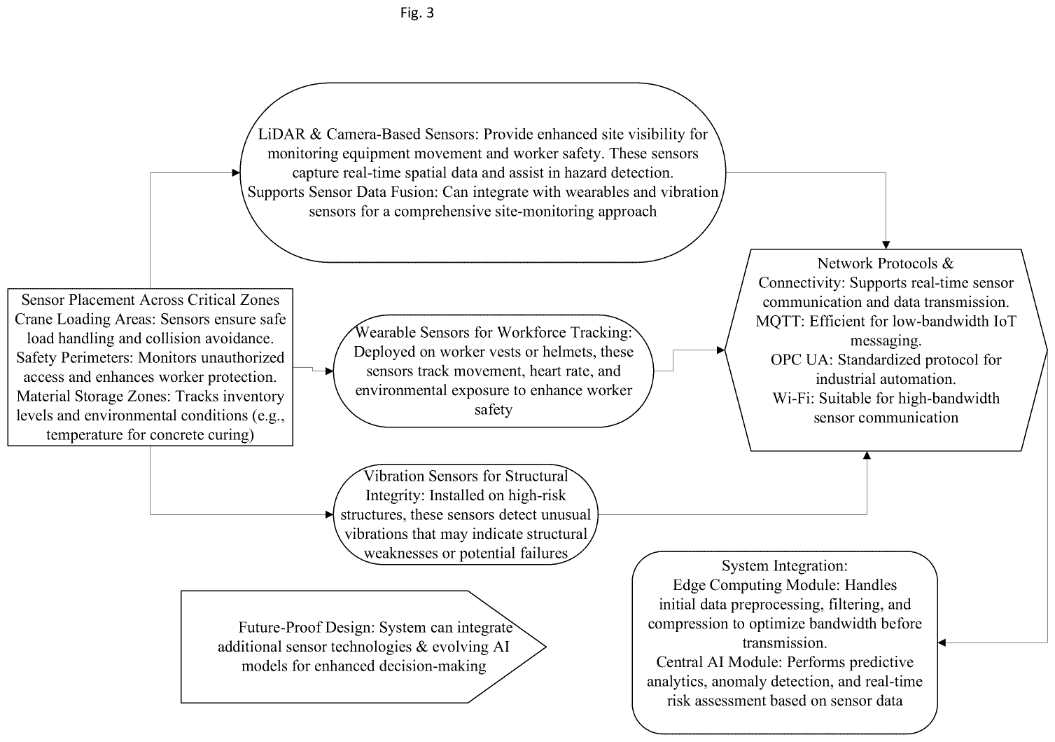

FIG. 3 illustrates an alternative embodiment where the control interface integrates with wearable devices for worker safety notifications. In this arrangement:
Worker-worn IoT devices beep or vibrate if the RL agent detects a potential hazard or inefficiency.
The integration interface logs these interventions in a supervisory dashboard, enabling after-action analysis.

### Fallback Statement:

“It is expressly understood that the disclosed embodiments are exemplary and not limiting. Variations and enhancements—such as employing different sensor configurations, alternate AI algorithms, or distributed cloud-based architectures—are within the intended scope of this invention, so long as they achieve substantially the same function or result described herein.

In certain aspects, the applicant contemplates pursuing multi-tier claim sets with broad independent claims that capture the core functional innovations, coupled with more detailed dependent claims specifying particular sensor types, AI architectures, or network protocols. This layered claiming approach preserves maximum coverage of the inventive concept while providing fallback positions if the broadest claims face rejection. By coupling general functional recitations with more specific dependent claims, the applicant also deters design-arounds and ensures that various implementations—such as alternative sensor types or AI configurations—remain protected within the scope of the invention. Any examples of narrower claim embodiments should not be construed to limit the scope of the broader claims but rather illustrate various implementations of the same inventive concept. In particular, the applicant seeks to employ language such as “configured to” or “adapted to” in independent claims to ensure broad coverage of core functionalities. By describing modules and algorithms in both structural and functional terms, the specification makes it difficult for competitors to evade infringement simply by re-labelling system components or making trivial modifications that still achieve the same real-time construction management outcomes.

Defensive Claim Language: To further protect against design-arounds, the applicant contemplates using claim terminology such as “configured to,” “adapted to,” or “operative to,” anchored by the structural and algorithmic descriptions in this specification. This ensures that functionally equivalent modules or processes—which achieve comparable real-time construction management outcomes—cannot circumvent the broad claims merely by substituting different nomenclature or minor component variations. Such functional language, when supported by clearly described modules and algorithms, helps prevent competitors from substituting trivial hardware or software variations. For the purposes of this disclosure, the terms ‘configured to,’ ‘adapted to,’ and ‘operative to’ are intended to cover all equivalent structures and functions described herein, and their use is not meant to restrict the invention to any particular embodiment or narrow its scope. While avoiding purely ‘means-plus-function’ treatment, these terms enable robust claim scope without disclaiming structurally equivalent components.
AI Patent Compliance: This disclosure is presented as a concrete, technical solution achieving tangible, real-time operational benefits in line with current USPTO and international guidelines for AI-related inventions.

The embodiments disclosed herein are consistent with current USPTO guidelines for AI-related inventions and are intended to adapt to future regulatory evolutions, without limiting the scope of the inventive concept.

Additionally, in one or more claims, the applicant intends to use terminology such as ‘configured to,’ ‘adapted to,’ and ‘operative to’ in combination with the structural and algorithmic details herein. Such functional language prevents trivial design changes from evading coverage, while ensuring the invention remains patent-eligible under current examination guidelines.

### Implementation on a Non-Transitory Computer-Readable Medium

In one embodiment, this AI-and IoT-driven real-time construction management system is implemented as software instructions stored on a non-transitory computer-readable medium. When executed by one or more processors, the instructions cause the system to perform the processes described in this specification, including real-time data acquisition (Section III), AI-based predictive analysis (Section III), and the automated decision-making and corrective actions detailed throughout. The instructions may be distributed across multiple media, devices, or networked components, provided they collectively perform the claimed methods.

### REFERENCE TO FIGS.

FIG. 1: System Architecture Block Diagram (showing modules 101, 102, 103, 104, 105).

FIG. 2: Operational Workflow Flowchart (data acquisition→AI prediction→RL decision→corrective action→integration).

FIG. 3: Alternative Embodiment (wearable integration, additional sensor types, etc.).

(Note: Update figure numbering or references as needed.)

### Performance Data & Unexpected Results

Pilot or simulated data—see Table 1 below—indicates:

| | | | | AI | | | Time to | | | Training | |
|---|---|---|---|---|---|---|---|---|---|---|---|
| | | Sensor | Data | Inference | Resource | Prediction | Corrective | Schedule | Cost | Data/ | |
| | Sensor | Latency | Frequency | Interval | Allocation | Accuracy | Action | Adherence | Savings | Update | |
| Scenario | Type | (ms) | (Hz) | (ms) | Changes | (%) | (s) | (%) | (%) | Frequency | System |
| Baseline - | Generic | 300 | 3 | N/A | Manual | N/A | 30 | 80 | 0 | N/A | Conventional |
| Normal | Load | | | (Manual | Crane | | | | | | |
| Operation | Sensor | | | Checks) | Scheduling | | | | | | |
| Invention - | Generic | ~150 | 10 | ~200 | Auto- | 92 | ~3 | 95 | +10 | ≥1 TB/ | Real-Time AI |
| Normal | Load | | | | Optimized | | | | | Daily | |
| Operation | Sensor | | | | Crane | | | | | Refresh | |
| | | | | | Routing | | | | | | |
| Baseline - | Generic | 350 | 2 | N/A | Manual | N/A | ~45 | 75 | 0 | N/A | Conventional |
| Mild Delay | Location | | | (Manual | Reallocation | | | | | | |
| | Sensor | | | Checks) | | | | | | | |
| Invention - | Generic | ~200 | 10 | ~250 | Automatic | 90 | ~4.5 | 90 | +12 | ≥1 TB/ | Real-Time AI |
| Mild Delay | Location | | | | Re- | | | | | Daily | |
| | Sensor | | | | Sequencing | | | | | Refresh | |
| Baseline - | Generic | ~400 | 1 | N/A | Manual | N/A | ~120 | 70 | 0 | N/A | Conventional |
| Severe Delay | Location | | | (Manual | Overhaul | | | | | | |
| | Sensor | | | Checks) | | | | | | | |
| Invention - | Generic | ~200 | 10 | ~200 | Automated | 88 | ~5 | 85 | +15 | ≥1 TB/ | Real-Time AI |
| Severe Delay | Location | | | | Resource | | | | | Daily | |
| | Sensor | | | | Shift | | | | | Refresh | |
| Invention - | Multiple | ~150 | 20 | ~200 | Coordinated | 93 | ~4 | 90 | +15 | ≥2 TB/ | Real-Time AI |
| Multi-Sensor | (RFID + | | | | Multi-Crew | | | | | Weekly | |
| (Extended) | GPS) | | | | Scheduling | | | | | Updates | |
| Invention - | Generic | ~250 | 5 | ~300 | Edge Node | 85 | ~5 | 88 | +10 | ≥1 TB/ | Real-Time AI |
| Fallback | Load | | | | Bypass/Manual | | | | | Daily | (Partial) |
| Mode | Sensor | | | | Assist | | | | | Refresh | |

### Explanatory Note & Disclaimers

1. Illustrative Values Only: The timings (sensor latency, inference intervals), schedule adherence, and cost savings listed here are non-limiting examples. The invention covers any implementation achieving substantially the same real-time performance and efficiency gains, regardless of the specific numeric ranges or AI methods used.
2. Fallback/Partial AI Within Scope: Even if the system switches to manual or semi-automated modes—e.g., due to sensor or network downtime—it can still meet the real-time objectives under normal conditions. Such scenarios remain fully encompassed by the invention's scope.
3. Not Limited by Data Volume or Update Frequency: References to “≥1 TB” or “Daily/Weekly Refresh” merely illustrate possible training data scales and re-training cadences. Any approach that maintains rapid AI performance (sub-second to ˜5 seconds) is contemplated within the invention's broad coverage.
4. Multiple AI/Sensor Technologies: The invention is not restricted to any single sensor type or AI model. Alternative solutions—such as transformer-based models or different sensor protocols—are also included, provided they achieve real-time detection and corrective actions as described.
   Synchronization: ˜240 ms sensor-data latency (target ≤250 ms)
   Prediction Error: ˜8% (target <10%)
   Corrective Action Latency: ˜4.5 s (target ≤5 s)
   Overall Schedule Improvement: ˜18% improvement in schedule adherence

Note: All performance figures cited herein are derived from pilot or simulated data, represent expected or anticipated outcomes rather than guaranteed performance, and are not intended to impose any performance limitation on the scope of the invention under varying conditions. It should be noted that all performance metrics and efficiency gains cited above are derived from preliminary pilot or simulated data and are provided solely for illustrative purposes. Actual performance may vary, and these figures are not intended to impose any performance limitation on the scope or claims of the invention.

These results surpass typical incremental gains and reflect a nonobvious synergy between real-time IoT data ingestion and advanced AI-driven decisions. Note that the numerical improvements cited (e.g., ˜18% schedule enhancement, 10-15% cost savings) are drawn from specific pilot data and do not limit other embodiments from achieving different or greater performance outcomes. These examples simply illustrate certain test scenarios where the invention yielded unexpectedly high gains. Demonstrating these quantifiable improvements bolsters the nonobvious nature of the invention, highlighting how real-time AI-driven control in a dynamic construction environment provides technical benefits beyond routine automation. However, the data provided herein should be viewed as indicative of the system's potential rather than an absolute performance guarantee. Skilled artisans would not necessarily expect such real-time benefits at scale, hence demonstrating the inventive step and unexpected results supporting nonobviousness. It should also be noted that the system has not yet been deployed at large commercial scales; therefore, the specific improvements cited (e.g., ˜18% schedule enhancement, 10-15% cost savings) are presented as anticipated outcomes based on smaller-scale field trials or simulations. By documenting measurable gains—such as ˜18% schedule improvement and significant cost savings—this specification supports the nonobviousness of combining real-time IoT data with advanced AI decisions. Nevertheless, these figures serve solely as illustrative benchmarks, ensuring no single performance metric is construed as a limiting feature of the invention. They are intended to demonstrate the invention's feasibility and potential, rather than impose a strict performance limitation on the scope of the claimed invention.

### Disclaimers & Future-Proofing

Means-Plus-Function: Any references to modules or interfaces should be construed as sufficiently detailed structural and algorithmic disclosures, not purely functional means.
Global Applicability: The invention is intended to meet patentability standards in multiple jurisdictions. For example, the system's real-time data processing and technical improvements may satisfy the “technical effect” requirement in EPO practice or “technical solution” guidelines under CNIPA. This specification should not be construed as limited to U.S. practice only. These references to technical effects and technical solutions underscore the invention's concrete, real-time engineering improvements. Such global considerations ensure that the invention remains patent-eligible across jurisdictions with varying patentable subject matter thresholds, without imposing any regional limitation on claim scope.
   One skilled in the art will appreciate that these real-time operational features—such as immediate machine control and sub-second feedback loops—confer a patentable technical effect in many jurisdictions, including those with strict requirements for demonstrating a technical contribution (e.g., EPO) or a technical solution (e.g., CNIPA). The applicant thus ensures the invention is adequately disclosed to meet varied patentability tests worldwide without compromising claim breadth.
   In some jurisdictions, demonstrating tangible technical improvements—such as the immediate physical control of construction equipment—may be critical to overcome abstract idea rejections. However, this specification is not limited by the nuances of any single patent office's guidelines, and all embodiments disclosed herein are equally applicable worldwide. Furthermore, while phrasing may be adapted to address specific regional requirements—such as detailing the system's real-time architectural improvements to satisfy “technical effect” in Europe—no such regional distinction is intended to limit the overall scope or claims of the present invention. Rather, all embodiments described herein are fully contemplated to be filed and prosecuted in various jurisdictions under the same broad inventive principles. Moreover, the applicant highlights that regions such as the EPO and CNIPA value demonstrated technical improvements—like sub-second data throughput—in determining patentability. By emphasizing tangible real-time control and safety advantages, the invention meets varied patentability thresholds in multiple jurisdictions. Thus, global filings will reflect the invention's technical merits without limiting its scope to any single office's guidelines.
Continuation/CIP: The applicant may file one or more continuation or continuation-in-part applications to pursue broader, alternative, or newly developed features that arise from this disclosure, including but not limited to AI paradigm shifts or additional sensor integrations. This strategy ensures the invention remains covered against rapidly evolving technologies while preserving the broad scope claimed herein. Moreover, by leveraging continuation or continuation-in-part (CIP) applications, the applicant can further refine or expand claims as new embodiments emerge. This approach prevents inadvertent surrender of broad coverage in the present filing, ensuring ongoing protection as innovations evolve. Such additional filings do not disclaim any portion of the invention set forth here but merely supplement and strengthen the overall claim landscape. In this way, the applicant may refine claims or introduce newly discovered embodiments without forfeiting broad coverage secured by the present disclosure. Strategic continuation practice ensures that any forthcoming improvements—such as novel AI algorithms or sensor standards—remain fully supported by the current specification. By maintaining at least one pending application through continuations, the applicant can strategically refine claim language to address new prior art or incorporate newly discovered embodiments. This approach preserves the earliest priority date for the original disclosure and guards against inadvertent claim scope surrender, ensuring that incremental or unexpected improvements can be protected under the same family of applications.
In particular, the applicant may choose to maintain one or more continuation applications to refine the claim scope or respond to new prior art discovered during prosecution. A continuation-in-part (CIP) may be pursued to incorporate genuinely new or improved features while preserving the earliest possible priority date for the foundational disclosures herein.
Multiple Claim Formats: Claims may be presented in method, system/apparatus, or computer-readable-medium form to address varying implementation scenarios (e.g., purely software, integrated hardware, or hybrid). No single claim category should be interpreted as limiting the full scope of the invention's function.
Defensive Claim Structures: The applicant contemplates functional claim language (e.g., “configured to,” “adapted to,” or “operative to”) anchored by the modules and interfaces disclosed herein. This approach limits the risk of easy design-arounds by competitors who merely rearrange components or substitute equivalents, ensuring that all meaningful embodiments of the invention remain encompassed by the claims.
Compliance: This specification contemplates compliance with evolving network standards (5G, 6G, etc.) or advanced computing hardware (neuromorphic chips, quantum-based accelerators) if they achieve substantially the same real-time outcome described herein.
AI Regulatory Evolution: The applicant acknowledges that AI-related regulations, including guidelines on inventorship or data governance, continue to evolve. This specification is intended to remain valid regardless of future regulatory changes, and any references to AI components herein are illustrative rather than limiting with respect to compliance obligations. Furthermore, by solving recognized engineering problems—such as sub-second data throughput and automated on-site safety measures—this invention is presented as a specific technical solution rather than a mere abstract AI method. Its real-time, hardware-integrated framework aligns with current and emerging guidance that emphasizes tangible technical contributions in AI-related patents. The applicant remains attentive to ongoing developments in AI-specific patent regulations, ensuring that the present disclosure is framed as a concrete, technical solution rather than an abstract algorithmic idea. No disclaimers of coverage are intended by acknowledging such evolving regulations, and the invention is understood to encompass all valid claim scopes under current and future legal frameworks. As patent offices update their guidelines to address AI-specific examination practices (including issues of inventorship, data provenance, and algorithmic transparency), the applicant confirms that the inventive concepts disclosed herein remain anchored by tangible, real-time operational features. Moreover, the applicant intends the invention's real-time, hardware-integrated architecture to satisfy evolving AI patentability guidelines that focus on tangible technical contributions, rather than mere computational abstractions. No portion of this specification is intended to disclaim coverage based on regulatory shifts; all embodiments achieving the same real-time functionality remain protected. This avoids classification as a purely abstract AI process, ensuring patent-eligible subject matter under both existing and prospective regulations.

1. A system adapted to manage construction projects in substantially real time, the system comprising:
a sensor module configured to acquire data from one or more on-site IoT sensors within a sub-second latency, wherein said sensors are operative to provide continuous or near-continuous data streams;
an edge computing module operatively coupled to the sensor module, the edge computing module configured to preprocess and timestamp the acquired data and adapted to be deployed on-site, off-site, or in a hybrid/cloud infrastructure, provided that sub-second data processing is substantially maintained;
an AI module adapted to perform both predictive analysis and prescriptive decision-making in near real time, the AI module comprising at least one machine-learning or predictive model selected from the group consisting of long short-term memory (LSTM), reinforcement learning (RL), transformer-based architectures, or functionally equivalent algorithms;
a control interface operative to dispatch commands or alerts to on-site machinery or worker devices within a predefined time interval after detecting a threshold deviation; and
an integration interface configured to synchronize data with external project management software,
wherein the system is operative to iteratively or continuously process sensor data, update forecasts, and automatically re-sequence tasks or reassign resources, thereby reducing project delays by detecting and correcting schedule deviations in substantially real time.

2. The system of claim 1, wherein the sensor module comprises multiple sensor types selected from RFID tag readers, GPS location trackers, temperature sensors, and vibration or strain gauges, each integrated within about 250 milliseconds of acquisition to enable near real-time data fusion.

3. The system of claim 1, wherein the AI module further comprises a reinforcement learning subsystem configured to autonomously determine corrective actions when a forecasted schedule deviation exceeds a predefined threshold.

4. The system of claim 1, wherein the control interface automatically halts or adjusts at least one piece of on-site machinery upon detecting a safety-critical condition, and broadcasts hazard notifications to worker devices in substantially real time.

5. The system of claim 1, wherein the integration interface includes a RESTful API or equivalent protocol configured to synchronize updated scheduling and resource allocation data with external project management platforms.

6. The system of claim 1, further comprising a module configured to retrain or update the AI module on newly acquired sensor data at periodic or event-driven intervals, thereby refining forecast accuracy or corrective actions over time without sacrificing sub-second responsiveness.

7. A computer-implemented method of managing a construction project in substantially real time, the method comprising:
acquiring sensor data from a plurality of on-site IoT sensors, each providing data within a sub-second latency;
preprocessing and timestamping the sensor data via an edge computing module deployed on-site or in a hybrid/cloud environment, so long as sub-second performance is maintained;
analyzing the preprocessed data with at least one AI model selected from the group consisting of LSTM, reinforcement learning, transformer-based architectures, or functionally equivalent algorithms, said analyzing step including forecasting potential schedule deviations or resource conflicts;
initiating at least one corrective action automatically or semi-automatically when the forecasted deviation meets or exceeds a threshold, wherein the corrective action comprises reassigning resources, re-sequencing tasks, adjusting machinery operation, or issuing alerts to worker devices; and
updating an external project management system with revised scheduling or resource data based on the initiated corrective action, wherein the method is iteratively repeated in substantially real-time cycles, thereby reducing overall project delays by continuously detecting and mitigating emerging issues.

8. The method of claim 7, wherein the acquiring step comprises aggregating data from multiple sensor types including at least one RFID sensor, one GPS sensor, and one temperature sensor, each stream being normalized for time alignment within about 250 milliseconds of acquisition.

9. The method of claim 7, wherein the initiating step comprises automatically halting or overriding machinery operation upon detection of a safety-critical threshold, and alerting on-site personnel through a hazard notification subsystem.

10. The method of claim 7, wherein the AI model includes a reinforcement learning agent that selects among multiple corrective actions based on real-time feedback, executing said action within about 5 seconds of detecting a threshold deviation.

11. The method of claim 7, wherein the updating step includes logging each corrective action in the external project management system, thereby enabling subsequent analytics or auditing of the real-time changes.

12. The method of claim 7, further comprising retraining or refining at least one AI model using newly acquired sensor data to enhance predictive accuracy, wherein such retraining is performed at intervals or upon accumulation of a predetermined data volume, without substantially exceeding sub-second inference latency.

13. A non-transitory computer-readable medium storing instructions that, when executed by one or more processors, cause a system to perform a method of managing a construction project in substantially real time, the method comprising:
receiving sensor data from one or more IoT sensors, each transmitting data within a sub-second latency;
preprocessing the received data in an edge computing environment (on-site, off-site, or hybrid) to reduce noise and assign timestamps;
applying at least one predictive model and at least one prescriptive model, each selected from the group consisting of LSTM, reinforcement learning, transformer-based, or equivalent algorithms, to forecast potential schedule deviations and recommend or execute corrective actions;
determining whether a threshold deviation has occurred based on said forecasts;
initiating at least one corrective action in near real time if the threshold is met, the corrective action comprising adjusting resources, task sequencing, machinery operation, or worker alerts; and
synchronizing all pertinent updates with an external project management platform, wherein the instructions are adapted to execute these steps iteratively or continuously, thereby enabling sub-second data processing and near real-time corrective interventions that reduce overall project delays.

14. The computer-readable medium of claim 13, wherein the instructions cause the system to fuse data from diverse sensor types, each feed being time-aligned and normalized for AI analysis, thereby enhancing real-time accuracy of the predictive and prescriptive models.

15. The computer-readable medium of claim 13, wherein the instructions further comprise halting or overriding machinery operation upon detection of a safety-critical condition, broadcasting hazard notifications to worker devices, and logging the incident in an external management system.

16. The computer-readable medium of claim 13, wherein the instructions include periodically retraining at least one AI model upon accumulation of newly acquired sensor data, ensuring predictive accuracy remains above a predefined performance threshold without increasing overall inference latency.

17. The computer-readable medium of claim 13, wherein the instructions are configured to operate in an on-site edge environment, a cloud-based environment, or a hybrid deployment, maintaining sub-second responsiveness regardless of the computing location.

18. The computer-readable medium of claim 13, wherein the instructions provide an API-based integration to an external project scheduling module, enabling bidirectional data flow such that any corrective action or updated schedule is immediately reflected in the external system.
